(19) United States
(12) Patent Application Publication
(10) Pub. No.: US 2015/0050068 A1
(43) Pub. Date: Feb. 19, 2015

(54) ELASTICALLY AVERAGED ALIGNMENT SYSTEMS AND METHODS THEREOF

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US); Joel Colombo, Howell, MI (US)

(73) Assignee: GM GLOBAL TECHNOLOGY OPERATIONS LLC, Detroit, MI (US)

(21) Appl. No.: 13/966,523

(22) Filed: Aug. 14, 2013

(51) Int. Cl. B62D 27/02; F16B 17/00

(52) U.S. Cl. CPC B62D 27/02; F16B 17/00
USPC 403/14; 29/446

(57) ABSTRACT

In one aspect, an elastically averaged alignment system is provided. The system includes a first component comprising an alignment member and a second component comprising an inner wall defining an alignment aperture. The alignment aperture is configured to receive at least a portion of the alignment member to couple the first component and the second component. At least one of the alignment member and the inner wall is an elastically deformable material such that when the alignment member is inserted into the alignment aperture, at least one of the alignment member and the inner wall elastically deforms to an elastically averaged final configuration to facilitate aligning the first component and the second component in a desired orientation

### FIELD OF THE INVENTION

The subject invention relates to matable components, and more specifically, to elastically averaged matable components for alignment and retention.

### BACKGROUND

Components, in particular vehicular components used in automotive vehicles, which are to be mated together in a manufacturing process are mutually located with respect to each other by alignment features that are oversized holes and/or undersized upstanding bosses. Such alignment features are sized to provide spacing to freely move the components relative to one another to align them without creating an interference therebetween that would hinder the manufacturing process. One such example includes two-way and/or four-way male alignment features, typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

As a result, significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignments may also affect the function and/or aesthetic appearance of the entire assembly. Regardless of whether such misalignment is limited to two components or an entire assembly, it can negatively affect function and result in a perception of poor quality. Moreover, clearance between misaligned components may lead to relative motion therebetween, which may cause undesirable noise such as squeaking and rattling.

Additionally, some components, particularly components made of compliant materials, may not remain mated to another component due to vehicle movement, passage of time, or other factors. As such, the male alignment features may become disengaged from corresponding female alignment features leading to additional noise and vibration.

### SUMMARY OF THE INVENTION

In one aspect, an elastically averaged alignment system is provided. The system includes a first component comprising an alignment member and a second component comprising an inner wall defining an alignment aperture. The alignment aperture is configured to receive at least a portion of the alignment member to couple the first component and the second component. At least one of the alignment member and the inner wall is an elastically deformable material such that when the alignment member is inserted into the alignment aperture, at least one of the alignment member and the inner wall elastically deforms to an elastically averaged final configuration to facilitate aligning the first component and the second component in a desired orientation

In another aspect, a vehicle is provided. The vehicle includes a body and an elastically averaged alignment system integrally arranged within the body. The elastically averaged alignment system includes a first component comprising an alignment member and a second component comprising an inner wall defining an alignment aperture. The alignment aperture is configured to receive at least a portion of the alignment member to couple the first component and the second component. At least one of the alignment member and the inner wall is an elastically deformable material such that when the alignment member is inserted into the alignment aperture, at least one of the alignment member and the inner wall elastically deforms to an elastically averaged final configuration to facilitate aligning the first component and the second component in a desired orientation.

In yet another aspect, a method of manufacturing an elastically averaged alignment system is provided. The method includes forming a first component comprising an alignment member, and forming a second component comprising an inner wall defining an alignment aperture. The alignment aperture is configured to receive at least a portion of the alignment member to couple the first component and the second component. The method further includes forming at least one of the alignment member and the inner wall from an elastically deformable material such that when the alignment member is inserted into the alignment aperture, at least one of the alignment member and the inner wall elastically deforms to an elastically averaged final configuration to facilitate aligning the first component and the second component in a desired orientation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary unassembled elastically averaged alignment system;

FIG. 2 is a cross-sectional view of the elastically averaged alignment system shown in FIG. 1, and after assembly;

FIG. 3 is a cross-sectional view of an another elastically averaged alignment system;

FIG. 4 is a cross-sectional view of yet another elastically averaged alignment system;

FIG. 5 is a cross-sectional view of yet another elastically averaged alignment system; and

FIG. 6 is a side view of a vehicle that may use any of the elastically averaged alignment systems shown in FIGS. 1-5.

### DETAILED DESCRIPTION

The following description is merely exemplary in nature and is not intended to limit the present disclosure, its application or uses. For example, the embodiments shown are applicable to vehicle body panels, but the alignment system disclosed herein may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are alignment and retention systems, as well as methods for elastically averaged mating assemblies. The alignment and retention systems include retention features that facilitate preventing unintentional disassembly of the elastically averaged mated assemblies, yet allow purposeful disassembly if desired. As such, the alignment and retention systems prevent accidental or premature separation of mated components, thereby maintaining a proper coupling between and desired orientation of two or more components.

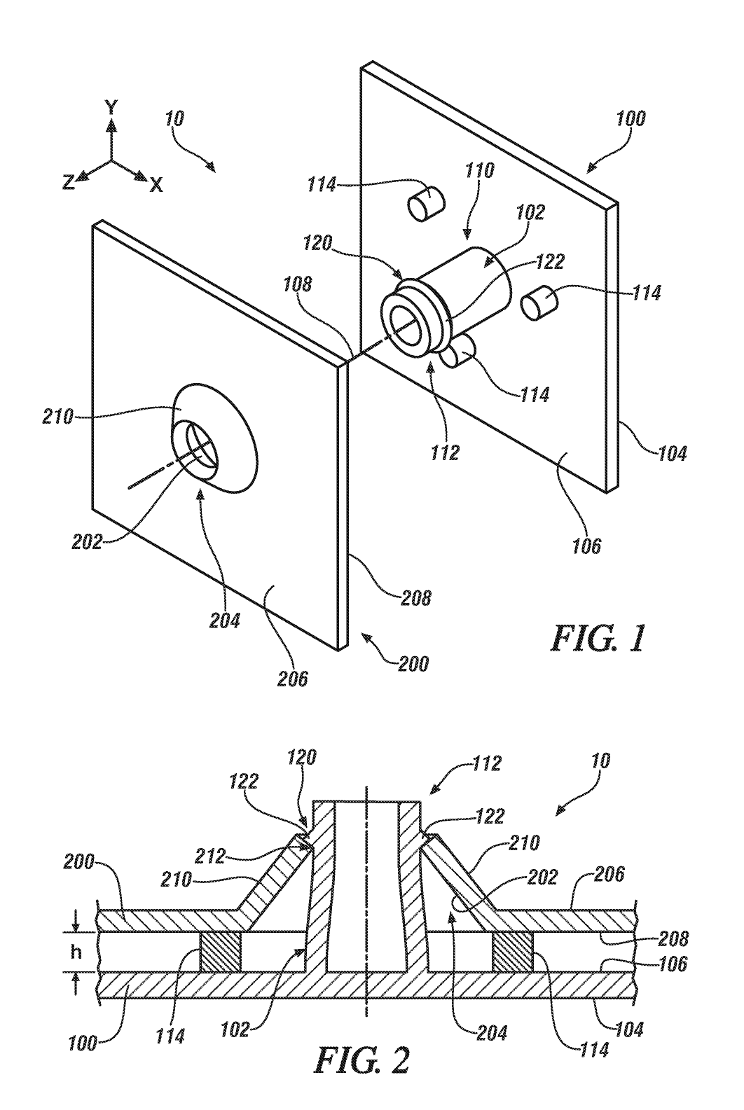

FIGS. 1 and 2 illustrate an exemplary elastically averaged alignment system 10 that generally includes a first component 100 to be mated to a second component 200 and retained in mated engagement by a retention feature 120. First component 100 includes an elastically deformable alignment member 102, and second component 200 includes an inner wall 202 defining an alignment aperture 204. Alignment member 102 and alignment aperture 204 are fixedly disposed on or formed integrally with their respective component 100, 200 for proper alignment and orientation when components 100 and 200 are mated. Although a single alignment member 102 and alignment aperture 204 are illustrated, components 100 and 200 may have any number and combination of corresponding alignment members 102 and alignment apertures 204. Elastically deformable alignment member 102 is configured and disposed to interferingly, deformably, and matingly engage alignment aperture 204, as discussed herein in more detail, to precisely align first component 100 with second component 200 in two or four directions, such as the ±x-direction and the ±y-direction of an orthogonal coordinate system, for example, which is herein referred to as two-way and four-way alignment.

In the exemplary embodiment, first component 100 generally includes an outer face 104 and an inner face 106 from which alignment member 102 extends. Alignment member 102 is a generally circular hollow tube having a central axis 108, a proximal end 110 coupled to inner face 106, and a distal end 112. However, alignment member 102 may have any cross-sectional shape that enables system 10 to function as described herein. First component 100 may optionally include one or more stand-offs 114 for engaging and supporting second component 200. In the exemplary embodiment, first component 100 is fabricated from an elastically deformable material such as plastic. However, first component 100 may be fabricated from any suitable material that enables system 10 to function as described herein.

Second component 200 generally includes an outer face 206, an inner face 208, and a flange 210 at least partially circumscribing alignment aperture 204. In the exemplary embodiment, alignment aperture 204 is illustrated as having a generally circular cross-section. Alternatively, alignment aperture 204 may have any shape that enables system 10 to function as described herein. For example, alignment aperture 204 may be an elongated slot (e.g., similar to the shape of elastic tube alignment system described in co-pending U.S. patent application Ser. No. 13/187,675 and particularly illustrated in FIG. 13 of the same). As best shown in FIG. 2, flange 210 includes inner wall 202 and extends outwardly from outer face 206 to define a generally converging or tapered lead-in or alignment aperture 204. As such, flange 210 provides a gradual lead in which simplifies locating alignment member 102 with alignment aperture 204, enables more consistent insertion forces, and facilitates quickly coupling first and second components 100 and 200. Alternatively, flange 210 may be oriented substantially perpendicular to outer face 206. Flange 210 may be formed by a punching process or by any other suitable method. In the exemplary embodiment, second component 200 is fabricated from a rigid material such as sheet metal. However, second component 200 may be fabricated from any suitable material that enables system 10 to function as described herein.

Moreover, inner wall 202 may be elastically deformable to facilitate added elastic average tuning of system 10. For example, inner wall 202 and/or a surrounding portion of second component 200 may be made from an elastically deformable material and/or have a smaller thickness or sheet metal gauge than the rest of component 200. As such, during insertion of alignment member 102 into alignment aperture 204, inner wall 202 and/or a surrounding portion of component 200 elastically deforms to an elastically averaged final configuration to facilitate aligning first component 100 and second component 200 in a desired orientation. Accordingly, first component tube thickness and second component material and/or gauge may be adjusted to tune the elastic average mating between first component 100 and second component 200.

While not being limited to any particular structure, first component 100 may be a decorative trim component of a vehicle with the customer-visible side being outer face 104, and second component 200 may be a supporting substructure that is part of, or is attached to, the vehicle and on which first component 100 is fixedly mounted in precise alignment.

To provide an arrangement where elastically deformable alignment member 102 is configured and disposed to interferingly, deformably and matingly engage alignment aperture 204, the diameter of alignment aperture 204 is less than the diameter of alignment member 102, which necessarily creates a purposeful interference fit between the elastically deformable alignment member 104 and alignment aperture 204. As such, when inserted into alignment aperture 204, portions of the elastically deformable alignment member 102 elastically deform to an elastically averaged final configuration that aligns alignment member 102 with the alignment aperture 204 in four planar orthogonal directions (the ±x-direction and the ±y-direction). Where alignment aperture 204 is an elongated slot (not shown), alignment member 102 is aligned in two planar orthogonal directions (the ±x-direction or the ±y-direction).

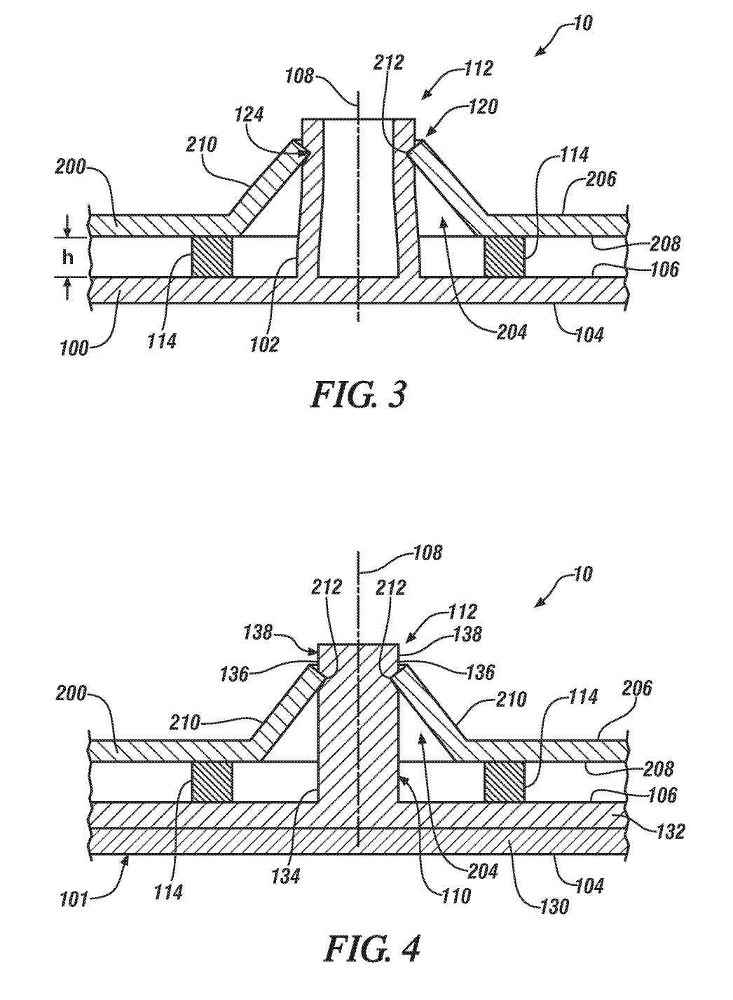

Alignment member 102 includes retention feature 120 that facilitates retention of alignment member 102 within alignment aperture 204. As shown in FIGS. 1 and 2, retention feature 120 is an edge or lip 122 extending from alignment member distal end 112. Lip 122 at least partially circumscribes alignment member 102 and is configured to engage an inner edge 212 of flange 210. For example, retention lip 122 interferingly engages flange inner edge 212 to increase the amount of force required to disengage or otherwise back-out alignment member 102 from within alignment aperture 204. FIG. 3 illustrates an alternative arrangement of retention feature 120. In the alternative embodiment, retention feature 120 is an indentation or recess 124 formed in alignment member distal end 112. Indentation 124 at least partially circumscribes alignment member 102 and is configured to receive and engage flange inner edge 212. For example, alignment member 102 is inserted into alignment aperture 204 until flange inner edge 212 is seated within indentation 124 to increase the amount of force required to disengage or otherwise back-out alignment member 102 from within alignment aperture 204. Accordingly, retention feature 120 results in improved retention of alignment member 102 within alignment aperture 204.

Moreover, standoffs 114 may be spaced relative to the outer diameter of alignment aperture 204 such that they provide a support platform at a height “h” above first component inner face 106. Second component inner face 208 rests upon standoff 114 when elastically deformable alignment member 102 is configured and disposed to interferingly, deformably and matingly engage alignment aperture 204. Stated alternatively, standoffs 114 are disposed and configured to provide a final relative position between alignment aperture 204 and elastically deformable alignment element 102 at an elevation “h” above inner face 106. While FIG. 1 depicts three standoffs 114 in the form of posts at a height “h” relative to first component inner face 106, it will be appreciated that the scope of the invention is not so limited and also encompasses other numbers and shapes of standoffs 114 suitable for a purpose disclosed herein, and also encompasses a standoff in the form of a continuous ring disposed around alignment member 102. All such alternative standoff arrangements are contemplated and considered within the scope of the invention disclosed herein. Moreover, while FIG. 1 depicts standoffs 114 integrally formed on inner face 106, it will be appreciated that a similar function may be achieved by integrally forming standoffs 114 on second component inner face 208, which is herein contemplated and considered to be within the scope of the invention disclosed herein.

FIG. 4 illustrates an alternative embodiment of alignment system 10 that is similar to the alignment system shown in FIGS. 1-3, but includes an alternate first component 101. Like reference numerals have been used to depict like parts. In the exemplary embodiment, first component 101 is formed from an outer material 130 and an inner material 132, which define outer face 104 and inner face 106, respectively. An alignment member 134 extends from inner face 106 and is a generally a solid, cylindrical protrusion having central axis 108, proximal end 110 coupled to inner face 106, and distal end 112. At least a portion of alignment member 134 includes a generally circular cross-section that is larger than alignment aperture 204 to provide an interference fit therebetween and at least partial compression of alignment member 134 as it is inserted through alignment aperture 204. Although described as generally circular, alignment member 134 may have any cross-sectional shape that enables system 10 to function as described herein.

First component 101 and/or second component 200 may optionally include one or more stand-offs (not shown) for supporting components 101 and 200. In the exemplary embodiment, first component 101 is fabricated from a compliant material. For example, outer material 130 may be an acoustic material such as for a vehicle headliner, and inner material 132 may be a fibrous or foam material, for example to stiffen outer material 130. However, first component 101 may be fabricated from any suitable compliant material that enables system 10 to function as described herein. Alternatively, outer material 130 and inner material 132 may be formed as a single unitary component.

Alignment member 134 is configured and disposed to interferingly, deformably, and matingly engage alignment aperture 204 in a manner similar to that described for alignment member 102, to precisely align first component 101 with second component 200 in two or four directions, such as the ±x-direction and the ±y-direction of an orthogonal coordinate system. However, alignment member 134 is fabricated from a suitable material that expands after insertion into alignment aperture 204. For example, as alignment member 134 is inserted through the lead in flange 210 of alignment aperture 204, it is compressed by flange 210, particularly inner edge 212, to cause a compressed body portion 136. As alignment member distal end 112 is inserted beyond flange 210, it expands to a diameter or cross-section that is larger than alignment aperture 204. As such, an expanded body portion 138 is oriented and configured to interferingly engage flange inner edge 212 to increase the amount of force required to disengage or otherwise back-out alignment member 134 from within alignment aperture 204. Accordingly, retention of alignment member 134 within alignment aperture 204 is improved.

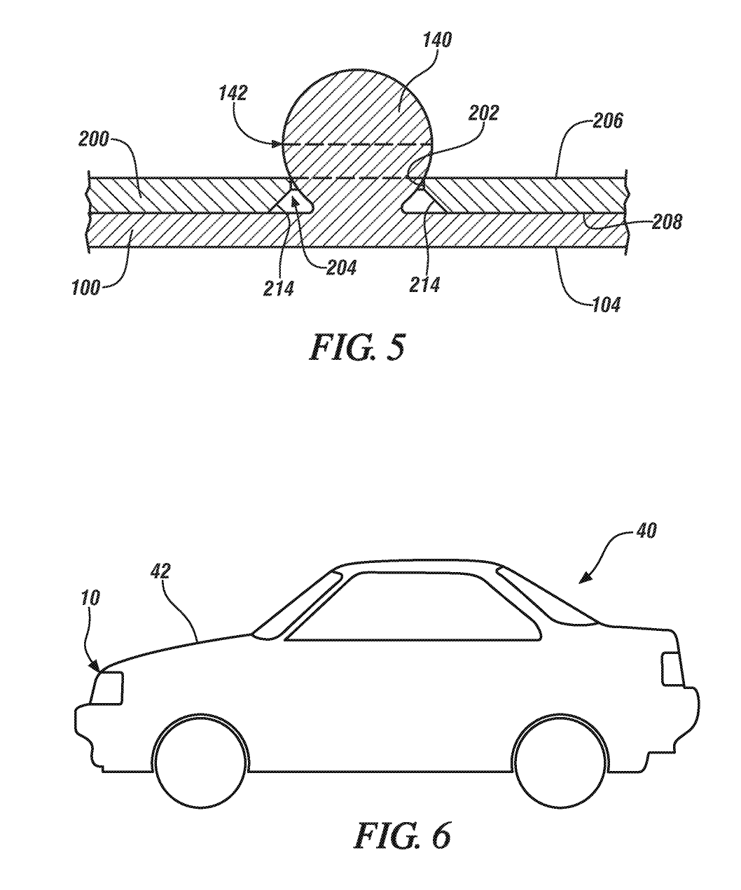

FIG. 5 illustrates an alternative embodiment of alignment system 10 that includes an alternative alignment member 140. Like numerals have been used to depict like parts. In the exemplary embodiment, alignment member 140 is generally spherical and may be fabricated from an elastically deformable compliant material. For example, alignment member 140 may be fabricated from foam, rubber, or soft plastics with minimal interferences. Although described as generally spherical, alignment member 140 may have any suitable shape that enables system 10 to function as described herein. For example, alignment member 140 may be generally hemispherical or teardrop shaped. Alignment member 140 includes a maximum diameter body portion 142 that has a larger cross-section than alignment aperture 204 to provide an interference fit therebetween and at least partial compression of alignment member 140 as it is inserted through alignment aperture 204.

Alignment member 140 is configured and disposed to interferingly, deformably, and matingly engage alignment aperture 204 in a manner similar to that described for alignment member 102, to precisely align first component 100 with second component 200 in two or four directions such as the ±x-direction and the ±y-direction of an orthogonal coordinate system. Alignment member 140 is fabricated from a suitable material that substantially maintains its original shape after being compressed through alignment aperture 204 to facilitate retention of alignment member 140 therein.

For example, as alignment member 140 is inserted through alignment aperture 204, larger cross-section body portion 142 is compressed by inner wall 202. Additionally, second component inner face 208 may include a chamfer 214 to facilitate insertion and compression of alignment member 140. As larger cross-section body portion 142 is inserted beyond second component outer face 206, it expands substantially to its original diameter or cross-section that is larger than alignment aperture 204. As such, body portion 142 is oriented and configured to interferingly engage second component outer face 206 and inner wall 202 to increase the amount of force required to disengage or otherwise back-out alignment member 140 from within alignment aperture 204. Accordingly, when alignment member 140 is seated within alignment aperture 204, the diameter of alignment member 140 located at outer face 206 is greater than or equal to the diameter of alignment aperture 204 to facilitate maintaining an interference fit therebetween. Accordingly, retention of alignment member 140 within alignment aperture is greatly improved. Moreover, body portion 142 provides a generally downward force against second component 200 that facilitates pushing first and second components 100 and 200 together.

Alternatively, or in addition, alignment member 140 may be fabricated from a rigid material and at least a portion of second component 200 may be fabricated from any suitable compliant material that enables alignment aperture 204 to elastically deform during insertion of alignment member 140. For example, as alignment member 140 is inserted through alignment aperture 204, inner wall 202 expands outward to enable larger cross-section body portion 142 to pass through alignment aperture 204. As body portion 142 is inserted beyond second component outer face 206, inner wall 202 contracts back to substantially its original diameter or cross-section that is smaller than body portion 142. As such, body portion 142 is oriented and configured to interferingly engage second component outer face 206 and inner wall 202 to increase the amount of force required to disengage or otherwise back-out alignment member 140 from within alignment aperture 204.

While FIGS. 1-5 depict just a single elastically deformable alignment member 102, 134, 140 in a corresponding aperture 204 to provide four-way alignment of the first component 100 relative to the second component 200, it will be appreciated that the scope of the invention is not so limited and encompasses other quantities and types of elastically deformable alignment elements used in conjunction with the elastically deformable alignment member 102, 134, 140 and corresponding aperture 204.

In view of all of the foregoing, and with reference now to FIG. 6, it will be appreciated that an embodiment of the invention also includes a vehicle 40 having a body 42 with an elastically averaging alignment system 10 as herein disclosed integrally arranged with the body 42. In the embodiment of FIG. 6, the elastically averaging alignment system 10 is depicted forming at least a portion of a front grill of the vehicle 40. However, it is contemplated that an elastically averaging alignment system 10 as herein disclosed may be utilized with other features or components of vehicle 40, such as interior trim, headliners, energy absorbing blocks, and door seals.

An exemplary method of fabricating elastically averaged alignment system 10 includes forming first component 100, 101 with at least one of alignment member 102, alignment member 134, and alignment member 140. First component 101 may be formed with outer material 130 and inner material 132. Second component 200 is formed with inner wall 202 defining alignment aperture 204, and flange 210 may also be formed in second component 200. At least one of alignment members 102, 134, 140, and alignment aperture 204 are formed to be elastically deformable such that when alignment member 102, 134, and/or 140 is inserted into alignment aperture 204, at least one of alignment member 102, 134, and/or 140, and/or inner wall 202 elastically deform to an elastically averaged final configuration to facilitate aligning first component 100, 101 and second component 200 in a desired orientation.

Retention lip 122 and/or retention indentation 124 may be formed on alignment members 102 to facilitate engagement and interference between alignment members 102 and second component 200. Alignment member 102 may be formed with a generally tubular body. Alignment member 134 may be formed with a diameter or cross-section larger than alignment aperture 204 and fabricated from a material that compresses during insertion into alignment aperture 204 and expands after passing through alignment aperture 204. Alignment member 134 may be formed with a substantially cylindrical shape and/or a slightly smaller diameter at the interface point to facilitate retention. Alignment member 140 may be formed with larger cross-section body portion 142 that is larger than alignment aperture 204 and may be formed with a substantially spherical, hemispherical, or teardrop shape. Alternatively, or additionally, at least a portion of second component inner wall 202 may be formed from an elastically deformable material that expands during insertion of alignment member 102, 134, and/or 140 and contracts after insertion of at least a portion of alignment member 102, 134, and/or 140.

Systems and methods for retention of elastically averaged mating assemblies are described herein. The systems generally include a first component with an elastically deformable alignment member positioned for insertion into an alignment aperture of a second component. The mating of the first and second components is elastically averaged over corresponding pair(s) of elastically deformable alignment members and alignment apertures to precisely mate the components in a desired orientation. Moreover, the systems include retention features for self-retention of the alignment members within the alignment apertures. The retention features include a lip or indentation formed on the alignment aperture to interferingly engage the second component, an alignment member that expands after insertion to interferingly engage the second component, and an elastically deformable alignment aperture that expands and contracts to interferingly engage the alignment member. Accordingly, the retention features facilitate preventing unintentional disassembly of elastically averaged mated components, tunable elastically averaged mating systems, reducing or eliminating the need for fasteners to mate the components, and elastic average mating of compliant materials.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising an alignment member; and
a second component comprising an inner wall defining an alignment aperture, said alignment aperture configured to receive at least a portion of said alignment member to couple said first component and said second component,
wherein at least one of said alignment member and said inner wall is an elastically deformable material such that when said alignment member is inserted into said alignment aperture, at least one of said alignment member and said inner wall elastically deforms to an elastically averaged final configuration to facilitate aligning said first component and said second component in a desired orientation.

2. The system of claim 1, wherein said alignment member comprises a body, at least a portion of said body having a cross-section larger than said alignment aperture, said larger cross-section body portion insertable through said alignment aperture and configured to maintain said larger cross-section body portion after insertion through said alignment aperture.

3. The system of claim 2, wherein one of said alignment member and said inner wall is rigid.

4. The system of claim 2, wherein said body is one of spherical, hemispherical, and teardrop shaped.

5. The system of claim 1, wherein said first component is fabricated from a compliant material.

6. The system of claim 2, wherein said alignment member is elastically deformable, said larger cross-section body portion configured to compress during insertion into said alignment aperture and to expand substantially to said larger cross-section body portion pre-compressed shape after passing through said alignment aperture, the expanded portion of said alignment member facilitating retention of said alignment member within said alignment aperture.

7. The system of claim 2, wherein said inner wall is elastically deformable, said inner wall configured to expand during insertion of said larger cross-section body portion into said alignment aperture and to contract substantially to said inner wall pre-expanded shape after said larger cross-section body portion passes through said alignment aperture, said inner wall facilitating retention of said alignment member within said alignment aperture.

8. The system of claim 1, said second component further comprising a flange extending therefrom, said flange comprising said inner wall defining said alignment aperture.

9. The system of claim 8, wherein said inner wall defines a converging alignment aperture.

10. The system of claim 1, wherein said alignment member comprises a retention feature configured to engage said inner wall and facilitate preventing said alignment member from backing out of said alignment aperture after insertion therein.

11. The system of claim 10, wherein said retention feature is a lip extending from said alignment member.

12. The system of claim 10, wherein said retention feature is an indentation formed in said alignment member, at least a portion of said inner wall configured to seat within said indentation.

13. A vehicle comprising:
a body; and
an elastically averaged alignment system integrally arranged within said body, said elastically averaged alignment system comprising:
a first component comprising an alignment member; and
a second component comprising an inner wall defining an alignment aperture, said alignment aperture configured to receive at least a portion of said alignment member to couple said first component and said second component,
wherein at least one of said alignment member and said inner wall is an elastically deformable material such that when said alignment member is inserted into said alignment aperture, at least one of said alignment member and said inner wall elastically deforms to an elastically averaged final configuration to facilitate aligning said first component and said second component in a desired orientation.

14. A method of manufacturing an elastically averaged alignment system, said method comprising:
forming a first component comprising an alignment member;
forming a second component comprising an inner wall defining an alignment aperture, the alignment aperture configured to receive at least a portion of the alignment member to couple the first component and the second component; and
forming at least one of the alignment member and the inner wall from an elastically deformable material such that when the alignment member is inserted into the alignment aperture, at least one of the alignment member and the inner wall elastically deforms to an elastically averaged final configuration to facilitate aligning the first component and the second component in a desired orientation.

15. The method of claim 14, further comprising forming the alignment member with a body portion having a cross-section larger than the alignment aperture, the larger cross-section body portion insertable through the alignment aperture and configured to maintain the larger cross-section body portion after insertion through the alignment aperture.

16. The method of claim 15, further comprising forming the alignment member from an elastically deformable material, the larger cross-section body portion configured to compress during insertion into the alignment aperture and to expand substantially to the larger cross-section body portion pre-compressed shape after passing through the alignment feature, the expanded portion of the alignment member facilitating retention of the alignment member within the alignment aperture.

17. The method of claim 15, further comprising forming the inner wall from an elastically deformable material, the inner wall configured to expand during insertion of the larger cross-section body portion into the alignment aperture and to contract substantially to the inner wall pre-expanded shape after the larger cross-section body portion passes through the alignment aperture, the inner wall facilitating retention of the alignment member within the alignment aperture.

18. The method of claim 14, further comprising forming the second component with a flange extending therefrom, the flange comprising the inner wall and defining a converging alignment aperture.

19. The method of claim 18, wherein the converging alignment aperture provides a lead in for the alignment member.

20. The method of claim 14, further comprising forming a retention feature on the alignment member, the retention feature configured to engage the inner wall and facilitate preventing the alignment member from backing out of the alignment aperture after insertion therein.
